(19) United States
(12) Patent Application Publication
(10) Pub. No.: US 2014/0334170 A1
(43) Pub. Date: Nov. 13, 2014

(54) LED LIGHT SOURCE ASSEMBLY FOR AUTOMOTIVE FORWARD LIGHTING APPARATUS

(71) Applicant: OSRAM GMBH, München (DE)

(72) Inventors: Haiqiang Zhong, Shenzhen Guangdong (CN); Haixiang He, Shenzhen Guangdong (CN); Xiangyu Dong, Kunshan Jiangsu (CN); Hu Wang, Shenzhen Guangdong (CN)

(21) Appl. No.: 14/360,935

(22) PCT Filed: Nov. 12, 2012
(86) PCT No.: PCT/EP2012/072358

§ 371 Date: May 28, 2014

(30) Foreign Application Priority Data
Nov. 29, 2011 (DE) 201120484207.2

(51) Int. Cl. F21S 8/10; F21V 15/01

(52) U.S. Cl. CPC F21S 48/32; F21V 15/011
USPC 362/487

(57) ABSTRACT

A LED light source assembly for an automotive forward lighting apparatus may include a LED lighting unit assembly provided with a LED lighting unit, a housing, and a heat transfer body which is assembled to the housing and to which the LED lighting unit assembly is assembled, wherein a mounting protuberance is provided at an outer circumference of the housing, and wherein the mounting protuberance is used to cooperate with a corresponding mounting groove in a holding bracket of the automotive forward lighting apparatus so as to install the LED light source assembly to the holding bracket by way of quarter turn installation.

### RELATED APPLICATIONS

The present application is a national stage entry according to 35 U.S.C. §371 of PCT application No.: PCT/EP2012/072358 filed on Nov. 12, 2012, which claims priority from Chinese application No.: 201120484207.2 filed on Nov. 29, 2011, and is incorporated herein by reference in its entirety.

### TECHNICAL FIELD

Various embodiments relate to a LED light source assembly for an automotive forward lighting apparatus, and more specifically, to a LED light source assembly in which the quarter turn installation feature and/or the shutter design are employed.

### BACKGROUND

Currently, in the field of automotive forward lighting, in addition to traditional lamps such as halogen lamp and xenon lamp, a LED (light-emitting diode) lamp, as a new light source, has been increasingly applied.

In present stage, however, a modular light source assembly, especially a LED light source assembly, is usually installed by way of thread installation. For example, a thread hole is provided in the light source assembly and a corresponding thread hole is provided in a corresponding mounting bracket (the mounting bracket being for example fixed to a reflector or lens in a vehicle lamp apparatus of an automobile), and then the light source assembly is installed to the mounting bracket by bolts. Thus, on the one hand, due to the necessity of machining the thread hole in the light source assembly and the mounting bracket and also due to the necessity of additionally using the bolts, the manufacturing process and the installing step are increased in number and then the manufacturing and installing costs are increased. On the other hand, the thread installation is an installation way of non-standard interface, and such installation way tends to cause the position of the light source assembly relative to the mounting bracket to vary after the installation. For example, in the thread installation way, generally it is hard to ensure the degree of tightness of the plurality of bolts to be completely identical, thus the light source assembly is caused to tilt relative to the mounting bracket after the installation. Accordingly, traditional installation ways such as the thread installation way can hardly ensure the lighting center of a lighting unit (for example a LED lighting unit) to be aligned with the optical center of the reflector or lens, so that the vehicle lamp apparatus is hard to achieve the optimal lighting effect.

In addition, in the present modular light source assembly (especially the LED light source assembly), a shutter, especially a shutter with a concrete shape, is not employed to cut the light beam to obtain a desired light style. Accordingly, it is hard for the vehicle lamp apparatus to reliably obtain the optimal cut light style, so that the need of the user for this cannot be met.

### SUMMARY

Various embodiments provide a LED light source assembly for an automotive forward lighting apparatus which is intended to solve or at least mitigate at least one of the drawbacks, as discussed above, existing in the related art.

According to various embodiments, a LED light source assembly for an automotive forward lighting apparatus is provided. The LED light source assembly includes: a LED lighting unit assembly provided with a LED lighting unit; a housing; and a heat transfer body which is assembled to the housing and to which the LED lighting unit assembly is assembled. A mounting protuberance is provided at an outer circumference of the housing, and the mounting protuberance is used to cooperate with a corresponding mounting groove in a holding bracket of the automotive forward lighting apparatus so as to install the LED light source assembly to the holding bracket by way of quarter turn installation.

In the above-mentioned LED light source assembly, preferably, the LED lighting unit assembly is a printed circuit board assembly.

In the above-mentioned LED light source assembly, preferably, the housing includes: a housing base being in form of a substantially circular plate and provided with a housing central hole; an axial protrusion being in a substantially cylindrical shape and extending upward from a periphery of the housing central hole of the housing base, the axial protrusion provided with an axial protrusion central hole, and the housing central hole and the axial protrusion central hole together forming a central through hole of the housing; and a lateral protrusion protruding outward from a part of an outer circumference of the housing base in the radial direction of the housing.

In the above-mentioned LED light source assembly, preferably, the outer diameter of the axial protrusion is smaller than that of the housing base so that in the housing a step portion is defined at a radial outer side of the axial protrusion.

In the above-mentioned LED light source assembly, preferably, the LED light source assembly further includes a flexible member being in a shape of a substantially circular ring, the flexible member engaged to the housing so as to surround the radial outer side of the axial protrusion and to be placed on the step portion for assisting in installing the LED light source assembly to the holding bracket by way of the quarter turn installation.

In the above-mentioned LED light source assembly, preferably, the heat transfer body includes: a heat transfer body base being in form of a substantially circular plate; and a column portion protruding upward from a central portion of the heat transfer body base and being in a shape of a substantially circular column, the column portion inserted in the central through hole of the housing.

In the above-mentioned LED light source assembly, preferably, the column portion has an upper surface, and the LED lighting unit assembly is assembled to the upper surface.

In the above-mentioned LED light source assembly, preferably, the number of the mounting protuberance is three.

In the above-mentioned LED light source assembly, preferably, the mounting protuberances are provided at the outer circumference of the axial protrusion equiangularly in the circumferential direction.

In the above-mentioned LED light source assembly, preferably, a first mounting protuberance of the mounting protuberances is disposed to be radially opposite to the lateral protrusion, the first mounting protuberance is composed of a first component, a second component and a third component spaced apart in the circumferential direction, and a lower surface of the second component is lower than a lower surface of the first component and a lower surface of the third component, a second mounting protuberance and a third mounting protuberance of the mounting protuberances are composed of a single component, respectively, and have substantially the same shape.

In the above-mentioned LED light source assembly, alternatively, a first mounting protuberance, a second mounting protuberance and a third mounting protuberance of the mounting protuberances are composed of a single component, respectively, the single component has an essentially cuboid shape, the top of the single component is beveled so that an inclined surface is formed, and a radial outer side surface of the single component is formed in a circular arc surface whose circle centre is the center of the housing.

In the above-mentioned LED light source assembly, preferably, the LED light source assembly further includes a cover being in a shape of a substantially circular ring, the cover connected to an axial free end of the axial protrusion.

In the above-mentioned LED light source assembly, preferably, the LED light source assembly further includes a shutter installed on the LED lighting unit assembly so as to be adjacent to the LED lighting unit for cutting a light style emitted by the LED lighting unit.

In the above-mentioned LED light source assembly, preferably, the shutter includes a body portion having a substantially cuboid shape and a flange portion extending outward from one side of the top of the body portion. In the above-mentioned LED light source assembly, preferably, a distal edge of the flange portion is straight and no gap, in a state where the shutter is installed to the LED lighting unit assembly, the distal edge is substantially located immediately above one edge of the LED lighting unit and a lower surface of the flange portion is spaced by a certain distance apart from an upper surface of the LED lighting unit in the vertical direction.

According to one or more embodiments of the present disclosure, the following advantageous effects can be achieved.

According to the LED light source assembly of the present disclosure, on the one hand, due to employing the quarter turn installation feature (that is, the mounting protuberance is provided at the outer circumference of the axial protrusion of the housing of the LED light source assembly, and correspondingly the mounting groove matchingly cooperating with the mounting protuberance is provided in the receiving through hole of the holding bracket), it is no longer necessary to machine the mounting hole (for example the thread hole) in the LED light source assembly and in the holding bracket and also it is no longer necessary to additionally use the bolt. Accordingly, the manufacturing process and the installing step are reduced in number and then the manufacturing and installing costs are reduced correspondingly. Meanwhile, the user (including the automobile manufacturer and the vehicle consumer) can quickly and conveniently in-stall the LED light source assembly onto the vehicle lamp apparatus (especially a forward lamp, for example a high beam, a dipped beam or a fog lamp) of the automobile.

Furthermore, since the quarter turn installation feature according to the present disclosure is employed, after the LED light source assembly is installed to the holding bracket, the rotation of the LED light source assembly in the circumferential direction relative to the holding bracket is reliably restricted by means of the engagement between the mounting protuberance and the stop surface of the mounting groove and the engagement between at least a lower part of the mounting protuberance and the recess of the mounting groove, the displacement of the LED light source assembly in the radial direction relative to the holding bracket is reliably restricted by means of the engagement between the radial outer side surface of the mounting protuberance and the side slide contact surface of the mounting groove of the holding bracket and the engagement between the outer circumferential surface of the axial protrusion of the housing and the contact surface of the projection of the mounting groove of the mounting groove, and the displacement of the LED light source assembly in the axial direction relative to the holding bracket is reliably restricted by means of the close engagement between the mounting protuberance and the lower slide contact surface or the recess on the lower slide contact surface under the biasing force generated due to the elastic recovery of the flexible member. Accordingly, the stable and exact positioning of the LED light source assembly relative to the holding bracket can be ensured after the LED light source assembly is installed to the holding bracket. Thereby, the alignment of the lighting center of the LED lighting unit of the LED light source assembly with the optical center of the reflector or lens can be ensured, such that the vehicle lamp apparatus can achieve the optimal lighting effect.

According to the LED light source assembly of the present disclosure, on the other hand, since the shutter (in particular a shutter module with a concrete shape) is employed to cut the light beam to obtain a desired light style, the vehicle lamp apparatus can reliably obtain the optimal cut light style, so that the need of the user is met.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a perspective view showing a LED light source assembly according to the exemplary embodiment of the present disclosure;

FIG. 2 is another perspective view showing the LED light source assembly according to the exemplary embodiment of the present disclosure;

FIG. 3 is yet another perspective view showing the LED light source assembly according to the exemplary embodiment of the present disclosure;

FIG. 4 is a top view showing the LED light source assembly according to the exemplary embodiment of the present disclosure;

FIG. 5 is a side view showing the LED light source assembly according to the exemplary embodiment of the present disclosure;

FIG. 6 is another side view showing the LED light source assembly according to the exemplary embodiment of the present disclosure;

FIG. 7 is an exploded perspective view showing the LED light source assembly according to the exemplary embodiment of the present disclosure;

FIG. 8 is a perspective view showing the shutter according to the exemplary embodiment of the present disclosure;

FIG. 9 is a sectional view taken along line A-A in FIG. 4 showing the LED light source assembly according to the exemplary embodiment of the present disclosure;

FIG. 10 is a perspective view showing the LED light source assembly with the heat dissipating device installed therein according to the exemplary embodiment of the present disclosure;

FIGS. 11A to 11D are perspective views showing a holding bracket used in conjunction with the LED light source assembly according to the exemplary embodiment of the present disclosure, respectively;

FIG. 12 is a plan view showing the holding bracket used in conjunction with the LED light source assembly according to the exemplary embodiment of the present disclosure; and

FIG. 13 a schematic view showing the assembling of the LED light source assembly to the holding bracket.

### DETAILED DESCRIPTION

The following detailed description refers to the accompanying drawing that show, by way of illustration, specific details and embodiments in which the disclosure may be practiced.

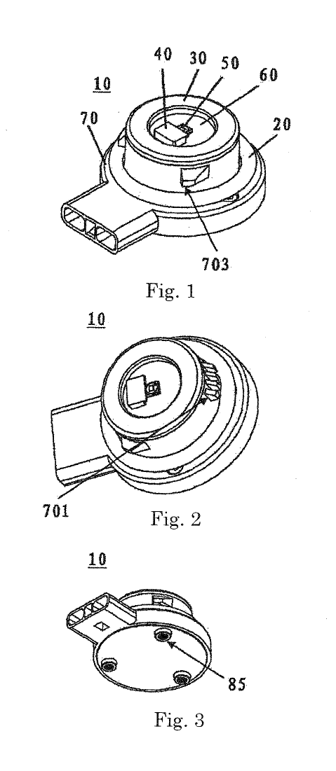

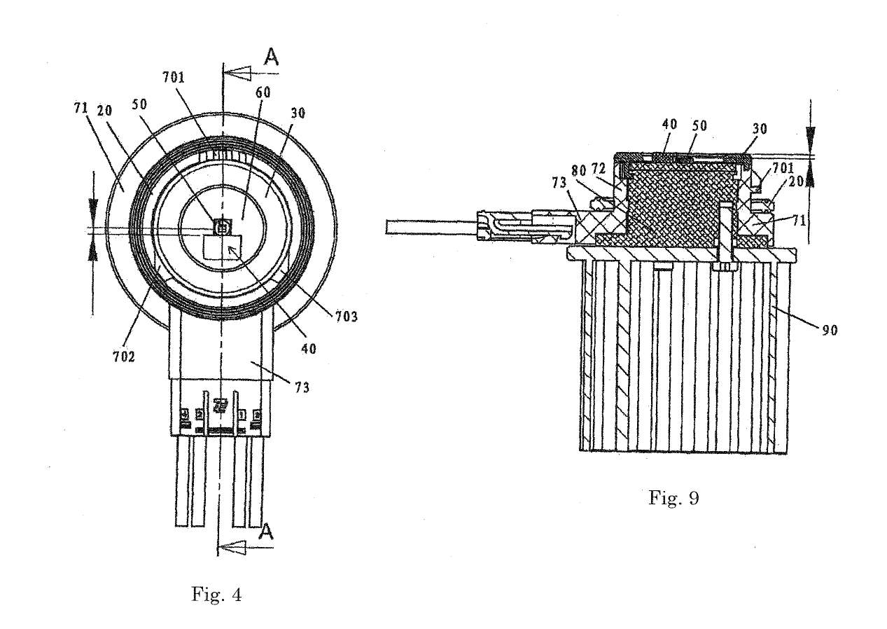

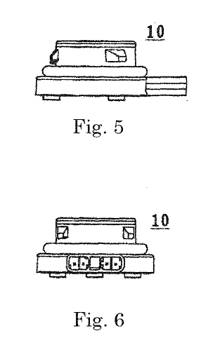

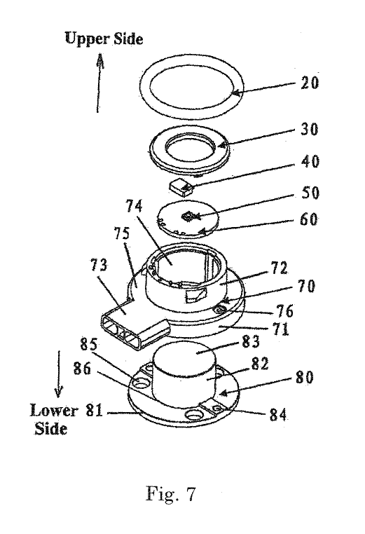

Reference is first made to FIGS. 1 to 7, wherein FIG. 1 is a perspective view showing a LED light source assembly according to the exemplary embodiment of the present disclosure, FIG. 2 is another perspective view showing the LED light source assembly according to the exemplary embodiment of the present disclosure, FIG. 3 is yet another perspective view showing the LED light source assembly according to the exemplary embodiment of the present disclosure, FIG. 4 is a top view showing the LED light source assembly according to the exemplary embodiment of the present disclosure, FIG. 5 is a side view showing the LED light source assembly according to the exemplary embodiment of the present disclosure, FIG. 6 is another side view showing the LED light source assembly according to the exemplary embodiment of the present disclosure, and FIG. 7 is an exploded perspective view showing the LED light source assembly according to the exemplary embodiment of the present disclosure.

In FIGS. 1 to 7, the LED (light-emitting diode) light source assembly is generally designated by reference number 10. Preferably, the LED light source assembly 10 is used in an automotive forward lighting apparatus.

In the exemplary embodiment, the LED light source assembly 10 may comprise a flexible member 20, a cover 30, a shutter 40, a printed circuit board assembly (PCBA) 60 with a LED lighting unit 50 (the printed circuit board assembly 60 serving as the LED lighting unit assembly according to the present disclosure), a housing 70 and a heat transfer body 80.

Generally, the housing 70 comprises a base 71, an axial protrusion 72 and a lateral protrusion 73.

In a preferred embodiment, the base 71 is in form of a substantially circular plate, and provided with a central hole (not indicated). In some embodiments, a mounting hole 76 is provided at a peripheral portion of the base 71, and the mounting hole 76 is used for mounting together the housing 70 and the heat transfer body 80 as will be further described below.

In a preferred embodiment, the axial protrusion 72 is in a substantially cylindrical shape and extends upward from a periphery of the central hole of the base 71. The axial protrusion 72 is also provided with a central hole (not indicated), and the central hole of the base 71 and the central hole of the axial protrusion 72 together form a central through hole 74 of the housing 70. Preferably, the central through hole 74 is a circular hole. The central through hole 74 is used for receiving a portion (i.e. a column portion 82) of the heat transfer body 80 as will be further described below.

In a preferred embodiment, the lateral protrusion 73 protrudes outward from a part of an outer circumference of the base 71 in the radial direction of the housing 70. The lateral protrusion 73 is used for receiving elements such as wiring terminal so as to electrically power the printed circuit board assembly 60 and thus the LED lighting unit 50. Preferably, the height of the lateral protrusion 73 is substantially the same as that of the base 71.

In a preferred embodiment, the outer diameter of the axial protrusion 72 is smaller than that of the base 71, so that in the housing 70 a step portion 75 is defined at a radial outer side of the axial protrusion 72. The step portion 75 is used for supporting the flexible member 20 as will be further described below.

In a preferred embodiment, the base 71, the axial protrusion 72 and the lateral protrusion 73 are formed integrally. However, those skilled in the art should appreciate that the base 71, the axial protrusion 72 and the lateral protrusion 73 may be formed separately and then assembled together by a proper way.

Generally, the flexible member 20 is in a shape of a substantially circular ring. The flexible member 20 is made of a suitable flexible material so that it is able to elastically deform under an outer force and then to elastically recover so as to tend to restore its original shape after the outer force is eliminated.

In a preferred embodiment, the flexible member 20 is embodied as a rubble gasket. The flexible member 20 is engaged to the housing 70. Specifically, after the assembling of the LED light source assembly 10 is completed, the flexible member 20 is positioned to surround the radial outer side of the axial protrusion 72 of the housing 70 and to be placed on the step portion 75 of the housing 70. The flexible member 20 serves to assist in achieving the quarter turn installation according to the present disclosure, which will be further described below.

Generally, the cover 30 is in a shape of a substantially circular ring. The cover 30 is connected to an axial free end of the axial protrusion 72 of the housing 70 so as to form a part of the appearance of the LED light source assembly 10. In some embodiments, the cover 30 may also function to assist in fixing the printed circuit board assembly 60 (as will be further described below) to the heat transfer body 80 (as will be further described below). In other embodiments, the printed circuit board assembly 60 and thus the LED lighting unit 50 are electrically connected to an external power source via a suitable electric connector provided in the cover 30.

In a preferred embodiment, the printed circuit board assembly 60 is substantially circular in shape, and the printed circuit board assembly 60 may be connected to the heat transfer body 80 (as will be further described below) using a suitable adhesive. The LED lighting unit 50 is assembled substantially at a center of the printed circuit board assembly 60. The LED lighting unit 50 has a lighting center. According to the present disclosure, preferably, after the assembling of the LED light source assembly 10 is completed, the lighting center of the LED lighting unit 50 substantially coincides with a center of the housing 70 (namely, a center of the base 71 and a center of the axial protrusion 72).

With additional reference to FIG. 8 (FIG. 8 is a perspective view showing the shutter according to the exemplary embodiment of the present disclosure), the shutter 40 may have a substantially cuboid shape with a step portion. Specifically, the shutter 40 comprises a body portion 41 and a flange portion 42. The body portion 41 has a substantially cuboid shape, and the flange portion 42 extends outward from one side of the top of the body portion 41 so that the step portion 43 is formed. In a preferred embodiment, a distal edge 44 of the flange portion 42 is straight and no gap.

With additional reference to FIG. 9 (FIG. 9 is a sectional view taken along line A-A in FIG. 4 showing the LED light source assembly according to the exemplary embodiment of the present disclosure), the shutter 40 is installed to be adjacent to the LED lighting unit 50. In a preferred embodiment, the shutter 40 is installed such that the distal edge 44 of the flange portion 42 is substantially located immediately above one edge of the LED lighting unit 50 and that a lower surface of the flange portion 42 is spaced by a certain distance apart from an upper surface of the LED lighting unit 50 in the vertical direction. However, those skilled in the art should appreciate that the specific shape of the shutter 40 and the positioning thereof relative to the LED lighting unit 50 may be varied, as long as a cut light style which is desired by the user can be obtained.

In some embodiments, the shutter 40 is fixedly installed to the printed circuit board assembly 60 by adhering a lower surface of the body portion 41 to the printed circuit board assembly 60 using a suitable adhesive.

Generally, the heat transfer body 80 comprises: a base 81 in form of a substantially circular plate; and a column portion 82 protruding upward from a central portion of the base 81 and being in a shape of a substantially circular column. The outer diameter of the column portion 82 is smaller than that of the base 81, so that in the heat transfer body 80 a step portion 86 is defined at a radial outer side of the column portion 82. An upper surface 83 of the column portion 82 is used for supporting the printed circuit board assembly 60. In some embodiments, a first mounting hole 84 is formed in the base 81 of the heat transfer body 80.

The first mounting hole 84 and the mounting hole 76 in the base 71 of the housing 70 are together used for receiving a fastener such as a bolt so as to fixedly install the heat transfer body 80 to the housing 70 with the column portion 82 inserted into the central through hole 74. In some embodiments, a second mounting hole 85 is formed in the base 81 of the heat transfer body 80. The second mounting hole 85 is used for receiving a fastener such as a bolt so as to install a heat dissipating device 90 such as a heat sink to a lower surface 87 of the base 81, as shown in FIG. 9.

Below, the assembling of the LED light source assembly according to the exemplary embodiment of the present disclosure is briefly described. With reference to FIG. 7, first, the heat transfer body 80 is installed to the housing 70 by a fastener such as a bolt. After this, the printed circuit board assembly 60 having the LED lighting unit 50 is installed to the upper surface 83 of the column portion 82 of the heat transfer body 80 (for example by an adhesive). Here, it is necessary to ensure that the lighting center of the LED lighting unit 50 substantially coincides with the center of the housing 70 (namely, the center of the base 71 and the center of the axial protrusion 72), and it is necessary to ensure that the LED lighting unit 50 is oriented properly. After this, the shutter 40 is installed to the printed circuit board assembly 60 (for example by an adhesive) such that the shutter 40 is positioned correctly relative to the LED lighting unit 50. Here, it should be understood that it is also possible to install the shutter 40 to the printed circuit board assembly 60 beforehand, and then the printed circuit board assembly 60 with the shutter 40 is installed to the upper surface 83 of the column portion 82 of the heat transfer body 80. Then, the cover 30 is installed to the axial free end of the axial protrusion 72 of the housing 70. Finally, the flexible member 20 is installed to the housing 70 such that the flexible member 20 surrounds closely the radial outer side of the axial protrusion 72 and abuts against the step portion 75.

According to the present disclosure, a mounting protuberance is provided at an outer circumference of the axial protrusion 72 of the housing 70. The mounting protuberance is used for cooperating with a corresponding mounting groove (as will be further described below) provided in a holding bracket so as to achieve the so-called quarter turn installation according to the present disclosure.

In the illustrated embodiment, at the outer circumference of the axial protrusion 72 of the housing 70, three mounting protuberances, including a first mounting protuberance 701, a second mounting protuberance 702 and a third mounting protuberance 703, are provided equiangularly in the circumferential direction.

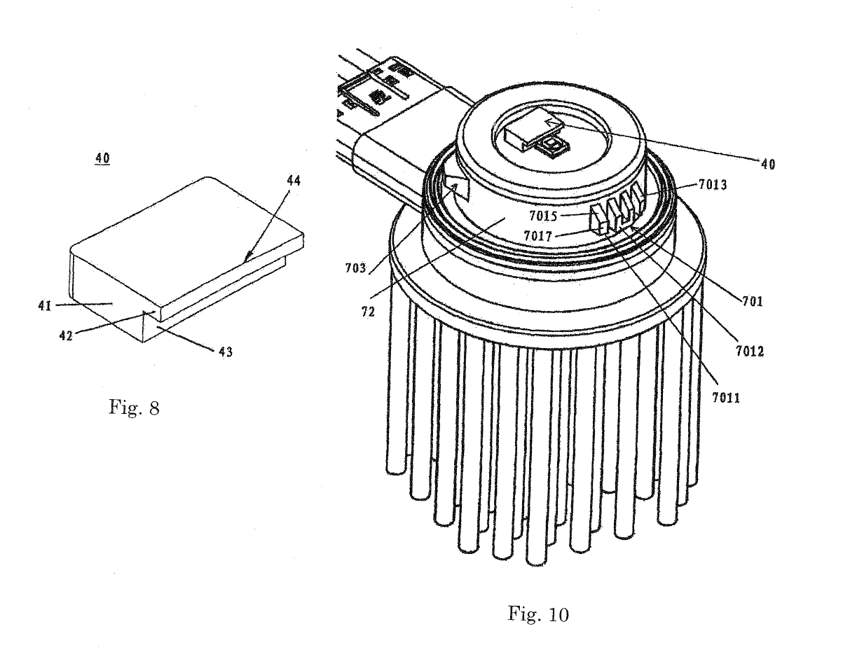

With reference to FIG. 4 and with additional reference to FIG. 10 (FIG. 10 is a perspective view showing the LED light source assembly with the heat dissipating device installed therein according to the exemplary embodiment of the present disclosure), in the illustrated embodiment, the first mounting protuberance 701 is disposed to be radially opposite to the lateral protrusion 73. The first mounting protuberance 701 may be composed of three components spaced apart by a certain distance in the circumferential direction, namely, a first component 7011, a second component 7012 and a third component 7013. A lower surface of the second component 7012 may be lower than a lower surface of the first component 7011 and a lower surface of the third component 7013.

In the illustrated embodiment, the second mounting protuberance 702 and the third mounting protuberance 703 may be composed of a single component, respectively, and the second mounting protuberance 702 and the third mounting protuberance 703 may have substantially the same shape.

In some embodiments, the mounting protuberance is not only used for carrying out the quarter turn installation, but also may serve as a reference point for the positioning of the printed circuit board assembly 60 and the LED lighting unit 50 relative to the housing 70.

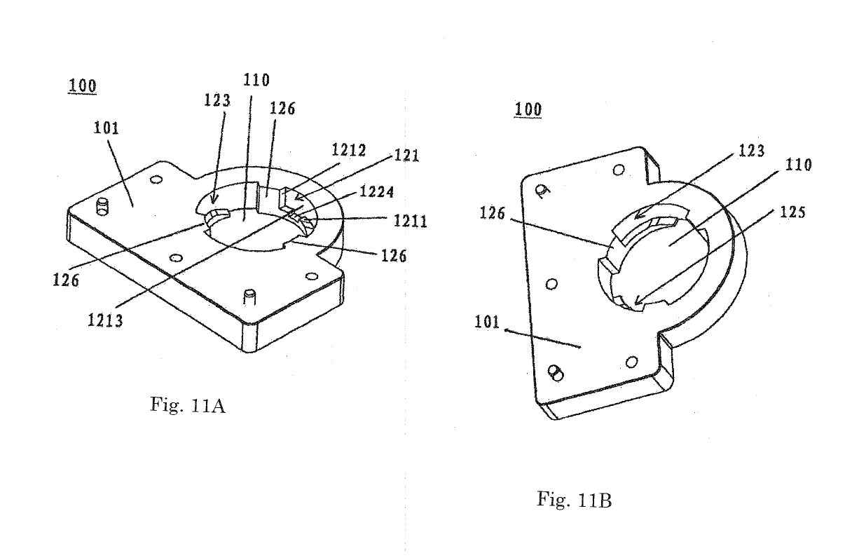

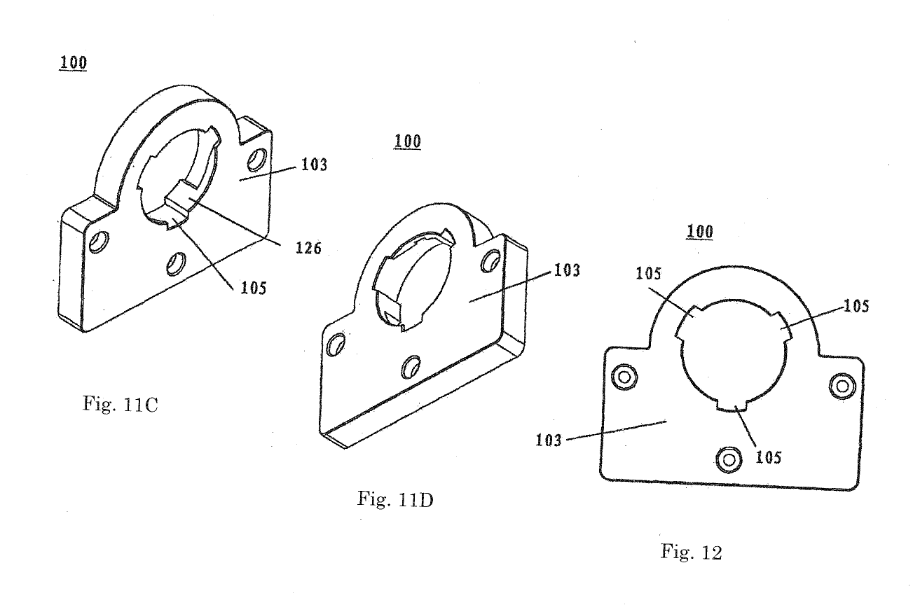

With reference to FIGS. 11A to 11D and FIG. 12 (FIGS. 11A to 11D are perspective views showing a holding bracket used in conjunction with the LED light source assembly according to the exemplary embodiment of the present disclosure, respectively, and FIG. 12 is a plan view showing the holding bracket used in conjunction with the LED light source assembly according to the exemplary embodiment of the present disclosure), generally, the holding bracket 100 used in conjunction with the LED light source assembly according to the exemplary embodiment of the present disclosure is fixed to a reflector or lens of a vehicle lamp apparatus (especially a forward lamp, for example a high beam, a dipped beam or a fog lamp) of an automobile. The holding bracket 100 has a receiving through hole 110, and the receiving through hole 110 is used for engaging with the axial protrusion 72 of the housing 70 of the LED light source assembly 10 so as to install the LED light source assembly 10 to the holding bracket 100 and thus to the vehicle lamp apparatus of the automobile.

In the illustrated embodiment, the receiving through hole 110 has an upper surface 101 and a lower surface 103. The receiving through hole 110 may have three passages 105 allowing the three mounting protuberances of the axial protrusion 72 to be inserted into the receiving through hole 110 from the lower surface side in the axial direction.

In the illustrated embodiment, the receiving through hole 110 may have three mounting grooves including a first mounting groove 121, a second mounting groove 123 and a third mounting groove 125. The first mounting groove 121 for cooperating with the first mounting protuberance 701 is described as an example. The first mounting groove 121 may comprise a lower slide contact surface 1211, a stop surface 1212 and a side slide contact surface 1213. The lower slide contact surface 1211 maybe inclined, and the lower surface of the first mounting protuberance 701 may slide along the lower slide contact surface 1211. The stop surface 1212 may limit the further rotation of the LED light source assembly 10 relative to the holding bracket 100 by abutting the first mounting protuberance 701 (particularly the third component 7013). The side slide contact surface 1213 is a circular arc surface. The diameter of a circle defined by each of the side slide contact surfaces of the first, second and third mounting grooves is basically equal to or slightly larger than the diameter of a circle defined by each of radial outer side surfaces of the first, second and third mounting protuberances, such that when the so-called quarter turn installation is carried out, the first, second and third mounting protuberances (particularly the radial outer side surfaces) can slide along the side slide contact surfaces of the first, second and third mounting grooves.

In the illustrated embodiment, a recess 1224, which is spaced apart from the stop surface 1212 by a proper distance, may be formed on the lower slide contact surface 1211 in the first mounting groove 121. The recess 1224 is used for receiving at least a lower part of the second component 7012 of the first mounting protuberance 701.

In the illustrated embodiment, the receiving through hole 110 may comprises three projections 126 protruding radially inward relative to the side slide contact surface of the mounting groove. Each projection 126 is located between one of the passages 105 and one of the mounting grooves. The projection 126 defines a contact surface 1261 in a circular arc shape and the above-mentioned stop surface (for example the stop surface 1212 of the first mounting groove 121). The diameter of a circle defined by each of the contact surfaces 1261 of the respective projections 126 is basically equal to or slightly larger than the outer diameter of the axial protrusion 72 of the housing 70 of the LED light source assembly 10, such that when the so-called quarter turn installation is carried out, an outer circumferential surface of the axial protrusion 72 can slide along the contact surface 1261 of the projection 126.

Here, it should be noted that the shape of each of the mounting protuberances and each of the mounting grooves illustrated in the drawings as well as the number thereof are for illustration purpose only. According to the present disclosure, the number and the concrete shape of the mounting protuberance may be varied as long as the quarter turn installation of the LED light source assembly 10 with the holding bracket can be achieved. Correspondingly, the number and the concrete shape of the mounting groove cooperating with the mounting protuberance may also be varied as long as the mounting groove can properly match the corresponding mounting protuberance.

For example, the mounting protuberance maybe composed of a single component whose shape is substantially the same as that of the first component 7011 of the first mounting protuberance 701 as shown in FIG. 10. That is, this single component and thus the mounting protuberance composed of this single component have an essentially cuboid shape. However, preferably, the top of the mounting protuberance is beveled so that an inclined surface 7015 is formed (this inclined surface facilitating the installation of the flexible member 20 to the step portion 75 of the housing 70). Also preferably, a radial outer side surface 7017 of the mounting protuberance is formed in a circular arc surface whose circle centre is the center of the housing 70 (namely, the center of the axial protrusion 72). Correspondingly, the mounting groove cooperating with the mounting protuberance may be configured to provide, on the lower slide contact surface, with a recess adjoining the stop surface so as to receive at least a lower part of the above-mentioned mounting protuberance.

In addition, in the illustrated embodiment, the concrete structure and shape of the first mounting protuberance 701 and those of the second, third mounting protuberances 702, 703 are not the same. However, those skilled in the art should appreciate that the first, second and third mounting protuberances 701, 702 and 703 may be configured to be completely the same in the structure and shape, and correspondingly, the first, second and third mounting grooves 121, 123 and 125 may be configured to be completely the same in the structure and shape.

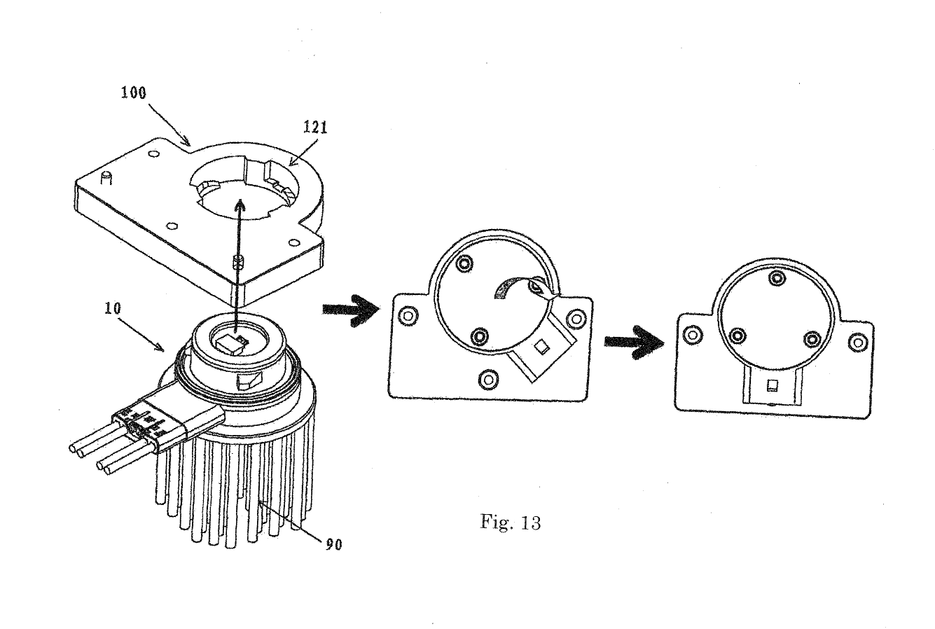

Below, the assembling of the LED light source assembly 10 to the holding bracket 100 (i.e. the quarter turn installation) is briefly described with reference to FIG. 13 (FIG. 13 a schematic view showing the assembling of the LED light source assembly to the holding bracket).

First, in a state where the mounting protuberance of the LED light source assembly 10 is aligned with the corresponding passage of the holding bracket 100, the axial protrusion 72 of the housing 70 of the LED light source assembly 10 is inserted into the receiving through hole 110 of the holding bracket 100 from the lower surface side of the holding bracket 100 in the axial direction (the upward direction as in the left view of FIG. 12). At this time, the flexible member 20 arranged on the step portion 75 of the housing 70 is pressed by the lower surface 103 of the holding bracket 100 so as to elastically deform.

Then, the LED light source assembly 10 is turned in a proper direction (such as the counterclockwise direction as in the left view of FIG. 12 or the clockwise direction as in the middle view of FIG. 12), such that the mounting protuberance slide along the lower slide contact surface and the side slide contact surface of the mounting groove, until the mounting protuberance abuts the stop surface of the mounting groove. At this time, in the case that the application of the outer force is stopped, the flexible member 20 elastically recovers. Since the holding bracket 100 is fixed onto the vehicle lamp structure of the automobile, the elastic recovery of the flexible member 20 urges the LED light source assembly 10 and thus the mounting protuberance to axially displace relative to the holding bracket 100, such that the mounting protuberance abut against the lower slide contact surface, or, in the case that the recess for receiving at least apart of the mounting protuberance is provided in the lower slide contact surface, the mounting protuberance is inserted into the recess.

Here, it should be noted that, according to the present disclosure, the “quarter turn installation” does not mean that it must turn the LED light source assembly exactly by a quarter of one turn (namely, by 90 degrees) during the installation. In fact, according to the present disclosure, the “quarter turn installation” means “turning a certain angle”, and this angle may be varied as long as the quick, convenient, stable and easily-aligned installation according to the present disclosure can be achieved.

According to the LED light source assembly of the present disclosure, on the one hand, due to employing the quarter turn installation feature (that is, the mounting protuberance is provided at the outer circumference of the axial protrusion of the housing of the LED light source assembly, and correspondingly the mounting groove matchingly cooperating with the mounting protuberance is provided in the receiving through hole of the holding bracket), it is no longer necessary to machine the mounting hole (for example the thread hole) in the LED light source assembly and in the holding bracket and also it is no longer necessary to additionally use the bolt. Accordingly, the manufacturing process and the installing step are reduced in number and then the manufacturing and installing costs are reduced correspondingly. Meanwhile, the user (including the automobile manufacturer and the vehicle consumer) can quickly and conveniently install the LED light source assembly onto the vehicle lamp apparatus (especially a forward lamp, for example a high beam, a dipped beam or a fog lamp) of the automobile.

Furthermore, since the quarter turn installation feature according to the present disclosure is employed, after the LED light source assembly is installed to the holding bracket, the rotation of the LED light source assembly in the circumferential direction relative to the holding bracket is reliably restricted by means of the engagement between the mounting protuberance and the stop surface of the mounting groove and the engagement between at least a lower part of the mounting protuberance and the recess of the mounting groove, the displacement of the LED light source assembly in the radial direction relative to the holding bracket is reliably restricted by means of the engagement between the radial outer side surface of the mounting protuberance and the side slide contact surface of the mounting groove of the holding bracket and the engagement between the outer circumferential surface of the axial protrusion of the housing and the contact surface of the projection of the mounting groove of the mounting groove, and the displacement of the LED light source assembly in the axial direction relative to the holding bracket is reliably restricted by means of the close engagement between the mounting protuberance and the lower slide contact surface or the recess on the lower slide contact surface under the biasing force generated due to the elastic recovery of the flexible member. Accordingly, the stable and exact positioning of the LED light source assembly relative to the holding bracket can be ensured after the LED light source assembly is installed to the holding bracket. Thereby, the alignment of the lighting center of the LED lighting unit of the LED light source assembly with the optical center of the reflector or lens can be ensured, such that the vehicle lamp apparatus can achieve the optimal lighting effect.

According to the LED light source assembly of the present disclosure, on the other hand, since the shutter (in particular a shutter module with a concrete shape) is employed to cut the light beam to obtain a desired light style, the vehicle lamp apparatus can reliably obtain the optimal cut light style, so that the need of the user is met.

Any reference in this specification to “exemplary embodiment”, “illustrated embodiment”, “preferred embodiment”, “some embodiments”, “other embodiments”, etc., means that a particular feature, structure, or characteristic described in connection with the embodiment is included in at least one embodiment of the present disclosure. The appearances of such phrases in various places in the specification are not necessarily all referring to the same embodiment. Further, when a particular feature, structure, or characteristic is described in connection with any embodiment, it is submitted that it is within the purview of those skilled in the art to effect such feature, structure, or characteristic in connection with other ones of the embodiments.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### EXPLANATION OF REFERENCE NUMERALS

10 LED light source assembly

20 flexible member

30 cover

40 shutter 4 body portion

42 flange portion

43 step portion

44 distal edge

50 LED lighting unit

60 printed circuit board assembly/LED lighting unit assembly

70 housing

71 base

72 axial protrusion

701 first mounting protuberance

702 second mounting protuberance

703 third mounting protuberance

7011 first component

7012 second component

7013 third component

7015 inclined surface

7017 radial outer side surface

73 lateral protrusion

74 central through hole

75 step portion

76 mounting hole

80 heat transfer body

81 base

82 column portion

83 upper surface

84 first mounting hole

85 second mounting hole

86 step portion

90 heat dissipating device

100 holding bracket

101 upper surface

103 lower surface

105 passage

110 receiving through hole

121 first mounting groove

123 second mounting groove

125 third mounting groove

126 projection

1211 lower slide contact surface

1212 stop surface

1213 side slide contact surface

1224 recess

1261 contact surface

1. A LED light source assembly for an automotive forward lighting apparatus comprising:
a LED lighting unit assembly provided with a LED lighting unit;
a housing; and
a heat transfer body which is assembled to the housing and to which the LED lighting unit assembly is assembled,
wherein a mounting protuberance is provided at an outer circumference of the housing, and
wherein the mounting protuberance is used to cooperate with a corresponding mounting groove in a holding bracket of the automotive forward lighting apparatus so as to install the LED light source assembly to the holding bracket by way of quarter turn installation.

2. The LED light source assembly according to claim 1, wherein the LED lighting unit assembly is a printed circuit board assembly.

3. The LED light source assembly according to claim 1, wherein the housing comprises:
a housing base being in form of a substantially circular plate and provided with a housing central hole;
an axial protrusion being in a substantially cylindrical shape and extending upward from a periphery of the housing central hole of the housing base, the axial protrusion provided with an axial protrusion central hole, and the housing central hole and the axial protrusion central hole together forming a central through hole of the housing; and
a lateral protrusion protruding outward from a part of an outer circumference of the housing base in the radial direction of the housing.

4. The LED light source assembly according to claim 3, wherein the outer diameter of the axial protrusion is smaller than that of the housing base so that in the housing a step portion is defined at a radial outer side of the axial protrusion.

5. The LED light source assembly according to claim 4, wherein the LED light source assembly further comprises a flexible member being in a shape of a substantially circular ring, the flexible member engaged to the housing so as to surround the radial outer side of the axial protrusion and to be placed on the step portion for assisting in installing the LED light source assembly to the holding bracket by way of the quarter turn installation.

6. The LED light source assembly according to claim 3, wherein the heat transfer body comprises:
a heat transfer body base being in form of a substantially circular plate; and
a column portion protruding upward from a central portion of the heat transfer body base and being in a shape of a substantially circular column, the column portion inserted in the central through hole of the housing.

7. The LED light source assembly according to claim 6, wherein the column portion has an upper surface, and the LED lighting unit assembly is assembled to the upper surface.

8. The LED light source assembly according to claim 3, wherein the number of the mounting protuberance is three.

9. The LED light source assembly according to claim 8, wherein the mounting protuberances are provided at the outer circumference of the axial protrusion equiangularly in the circumferential direction.

10. The LED light source assembly according to claim 9, wherein a first mounting protuberance of the mounting protuberances is disposed to be radially opposite to the lateral protrusion, the first mounting protuberance is composed of a first component, a second component and a third component spaced apart in the circumferential direction, and a lower surface of the second component is lower than a lower surface of the first component and a lower surface of the third component, a second mounting protuberance and a third mounting protuberance of the mounting protuberances are composed of a single component, respectively, and have substantially the same shape.

11. The LED light source assembly according to claim 9, wherein a first mounting protuberance, a second mounting protuberance and a third mounting protuberance of the mounting protuberances are composed of a single component, respectively, the single component has an essentially cuboid shape, the top of the single component is beveled so that an inclined surface is formed, and a radial outer side surface of the single component is formed in a circular arc surface whose circle center is the center of the housing.

12. The LED light source assembly according to claim 1, wherein the LED light source assembly further comprises a cover being in a shape of a substantially circular ring, the cover connected to an axial free end of the axial protrusion.

13. The LED light source assembly according to claim 1, wherein the LED light source assembly further comprises a shutter installed on the LED lighting unit assembly so as to be adjacent to the LED lighting unit for cutting a light style emitted by the LED lighting unit.

14. The LED light source assembly according to claim 13, wherein the shutter comprises a body portion having a substantially cuboid shape and a flange portion extending outward from one side of the top of the body portion.

15. The LED light source assembly according to claim 14, wherein a distal edge of the flange portion is straight and no gap, in a state where the shutter is installed to the LED lighting unit assembly, the distal edge is substantially located immediately above one edge of the LED lighting unit and a lower surface of the flange portion is spaced by a certain distance apart from an upper surface of the LED lighting unit in the vertical direction.
